(19) United States
(12) Patent Application Publication
(10) Pub. No.: US 2011/0298584 A1
(43) Pub. Date: Dec. 8, 2011

(54) SECURING A CASH SAFE WITH A CIRCUIT

(76) Inventors: Kent Biggs, Tomball, TX (US); Michael A. Provencher, Cypress, TX (US); Stephen J. Higham, Houston, TX (US)

(21) Appl. No.: 12/793,856

(22) Filed: Jun. 4, 2010

(51) Int. Cl. G06F 7/04

(52) U.S. Cl. 340/5.73

(57) ABSTRACT

Disclosed embodiments relate to a method for opening a cash safe secured with a circuit. For example, the method may comprise receiving a key by a circuit connected to a locking mechanism for securing a cash safe closed and retrieving, by the circuit, a stored key. The method may further comprise comparing, by the circuit, the received key to the stored key, determining, by the circuit, whether to release the cash safe based on the comparison, and sending, by the circuit, a signal to release the locking mechanism securing the cash safe closed if determined to release the cash safe.

### BACKGROUND

A cash safe, such as a cash drawer associated with a cash register, may store valuable items. In order to better protect assets stored within a cash safe, the cash safe may be configured so that it may not be easily tampered with or compromised. For example, electrical mechanisms for securing a cash safe may be used to prevent unauthorized people from gaining access to cash and other valuables stored inside.

### BRIEF DESCRIPTION OF THE DRAWINGS

In the accompanying drawings, like numerals refer to like components or blocks. The following detailed description references the drawings, wherein:

FIG. 1 is a diagram illustrating one embodiment of an electronic cash safe system.

FIG. 2 is a block diagram illustrating one embodiment of an electronic cash safe system.

FIG. 3 is a flow chart illustrating one embodiment of a method for securing a cash safe with a circuit.

FIG. 4 is a block diagram illustrating one embodiment of an electronic cash safe system.

FIG. 5 is a block diagram illustrating one embodiment of an electronic cash safe system.

FIG. 6 is a flow chart illustrating one embodiment of a method for opening a cash safe secured with a circuit.

FIG. 7 is a block diagram illustrating one embodiment of an electronic cash safe system.

### DETAILED DESCRIPTION

A cash safe, such as a cash drawer or cash box, associated with a cash register or other electronic device may include a locking mechanism for securing the cash safe, for example, to prevent theft of cash, checks, or other valuables stored inside. A physical lock and key may be used to lock a cash safe to prevent it from opening. However, this may involve a person being available to physically lock the cash safe, and someone in possession of the key could potentially gain access to the cash safe. In some cases, a cash safe may be secured by using an electrical mechanism, such as a circuit. A cash safe may include a circuit that sends a signal to release a locking mechanism to allow the cash safe to open. However, such a mechanism may be tampered with at the circuit level. For example, an intruder may open the cash safe by interfering with a phone port to trigger the circuit to send a signal to release the locking mechanism. A password may be used to make a cash safe more secure. For example, a user may enter a password that causes an electronic device to send a signal to a circuit instructing it to release a locking mechanism securing the cash safe. Again, an intruder may be able to open the cash safe by interfering with the circuit because the circuit logic itself may operate independent of the password.

In one embodiment, a cash safe includes a circuit evaluating a digital key for securing the cash safe. For example, a circuit connected to a locking mechanism for securing a cash safe may receive a key, such as from an electronic device connected to the circuit, when an attempt is made to open the cash safe. The circuit may determine whether the received key corresponds to a key stored in a storage associated with the circuit, such as by determining whether the keys match. If the keys correspond to each other, the circuit may send a signal to release the locking mechanism, resulting in the cash safe being unlocked or automatically opening. If the received key does not correspond to the stored key, the circuit may refrain from transmitting a signal to release the locking mechanism, thereby, securing the cash safe in a closed position.

In one embodiment, a cash safe operates in both a secure and non-secure mode. For example, a circuit connected to a cash safe may operate in a non-secure mode such that the circuit sends a signal to a locking mechanism to release the cash safe without evaluating a key. The circuit may receive a key indicating that the cash safe should be secured. The circuit may store the received key and secure the cash safe such that it may be secured closed in the future unless it receives a key corresponding to the stored key. In one embodiment, a cash safe may be secured from a remote electronic device. For example, a user may instruct a remote electronic device to secure a cash safe, and the remote electronic device may transmit an instruction or key via a network to a circuit connected to the cash safe.

In one embodiment, a circuit connected to a cash safe stores an identifier, such as a serial number, associated with the cash safe. The circuit may send information about the identifier to an electronic device so that the electronic device may track information about the cash safe, such as the assets stored in a particular cash safe within a group of cash safes. The identifier may also be used, for example, to identify which cash safes within a group of cash safes are operating in a secure or non-secure mode.

A cash safe secured by a circuit evaluating a key provides advantages. For example, allowing a circuit to control both the security and releasing mechanism of a cash safe may be more difficult to interfere with than a system where security measures are external from the circuitry for releasing the cash safe. An intruder without access to the proper key or access to an application with the proper key may be prevented from accessing the contents of the cash safe. A cash safe capable of operating within multiple modes may allow a cash safe to be secured according to the circumstances. For example, a remote electronic device may control the security of multiple cash safes, such as cash safes within a bank. An alarm may indicate that a bank is being robbed, and an administrator in a remote location may be able to send an instruction to each of the circuits associated with the cash safes in the bank from the remote electronic device. In addition, the use of a digital key to secure a cash safe provides a simple method for security that may be easily implemented. Allowing a circuit connected to a cash safe to store and transmit information identifying a cash safe may be useful for tracking assets and the security state of a cash safe.

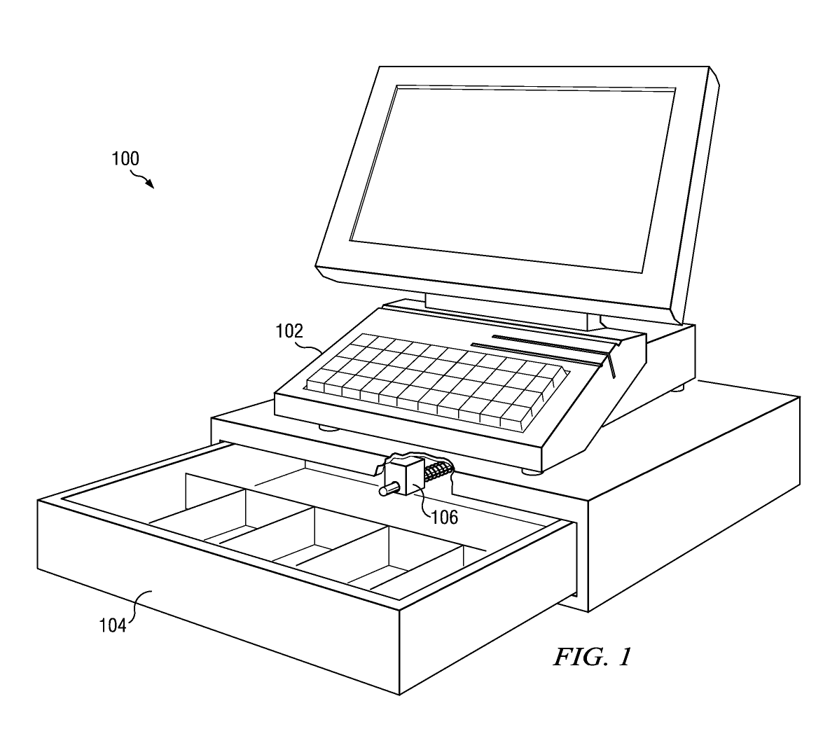

FIG. 1 is a diagram illustrating one embodiment of an electronic cash safe system 100. The electronic cash safe system 100 may include, for example, a cash safe 104, a locking mechanism 106, and an electronic device 102. The cash safe 104 may be any suitable cash safe. For example, the cash safe 104 may be a cash drawer, such as a cash register drawer, for storing cash or other small items or valuables. The cash safe 104 may slide into a drawer housing. In some cases, the cash safe 104 may be a cash box opened by removing or opening a lid covering the top of the cash box. The locking mechanism 106 may be any suitable locking mechanism, such as a latch. In some cases, the locking mechanism 106 may be a spring loaded solenoid. In one embodiment, the locking mechanism 106 secures the cash safe 104 closed, such as by securing the cash safe 104 in a drawer housing or securing a lid on the cash safe 104. The electronic device 102 may be any suitable electronic device, such as a cash register or computer. In one embodiment, the electronic device 102 communicates with the cash safe 104.

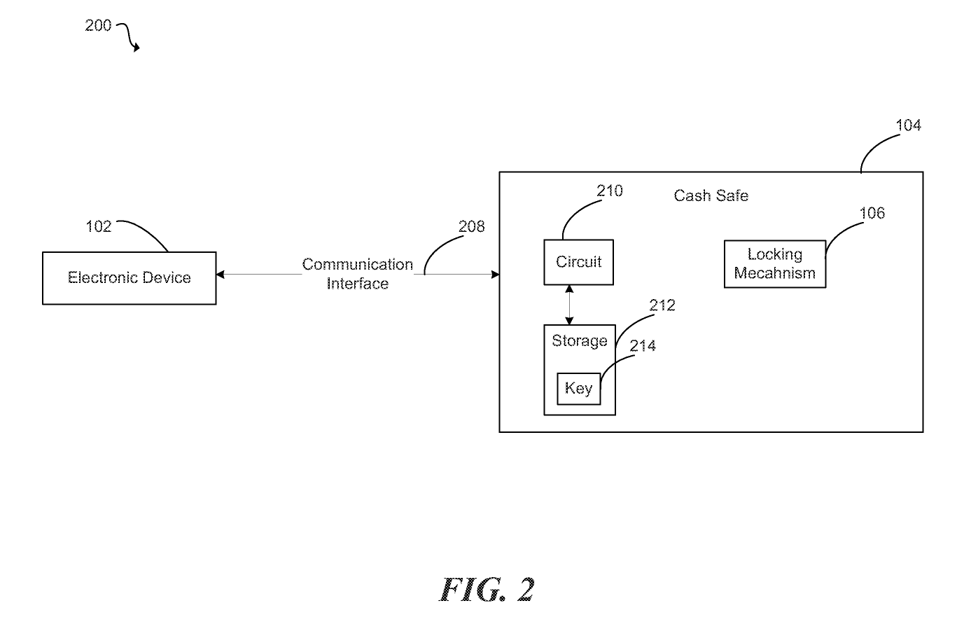

FIG. 2 is a block diagram illustrating one embodiment of an electronic cash safe system 200 showing the individual components of the electronic cash safe system 100. The electronic cash safe system 200 may include, for example, the cash safe 104, the locking mechanism 106, and the electronic device 102. The electronic cash safe system 200 may also include a circuit 210, a storage 212, and a communication interface 208.

The circuit 210 may be any suitable circuit for controlling the locking mechanism 106. The circuit 210 may be, for example, part of the cash safe 104 or connected to the cash safe 104. The circuit 210 may send a signal to the locking mechanism 106 causing the locking mechanism 106 to release the cash safe 104 such that the cash safe 104 may be opened by removing it from an enclosure or opening a lid or other portion of the cash safe 104. For example, the circuit may send a signal to alter the voltage across two pins connected to the locking mechanism 106 in order to provide power to the locking mechanism 106, which then releases the cash safe 104. In some implementations, the cash safe 104 may be closed, such as by sliding it into a housing or closing a lid, to reset the locking mechanism 106 and the logic of the circuit 210.

The storage 212 may be any suitable storage medium for storing information accessible by the circuit 210. The storage 212 may be a volatile or non-volatile storage. In some implementations, the storage 212 stores a key 214. The key 214 may be written to the storage 212 by the circuit 210. In some cases, the key 214 is a write only field such that the circuit 210 does not transmit information about it to the electronic device 102. In one embodiment, the electronic cash safe system 200 includes both a volatile and non-volatile storage. For example, a portion of the key 214 may be stored in a volatile storage and a portion of the key 214 may be stored in a non-volatile storage. In one embodiment, the circuit 210 retrieves the key 214 to compare it to a received key. In some implementations, the electronic cash safe system 200 may include one circuit for storing the key 214 and another circuit for comparing the key 214 to a received key.

In one embodiment, the electronic device 102 communicates with the circuit 210 via a communication interface 208. For example, the electronic device 102 may send a key to the circuit 210 via the communication interface 208. The communication interface 208 may be any suitable type of communication interface, such as an Inter-Integrated Circuit (I2C), Universal Serial Bus (USB), or IEEE 1394 interface. In one embodiment, the electronic device 102 houses the circuit 210, the cash safe 104, and the communication interface 208.

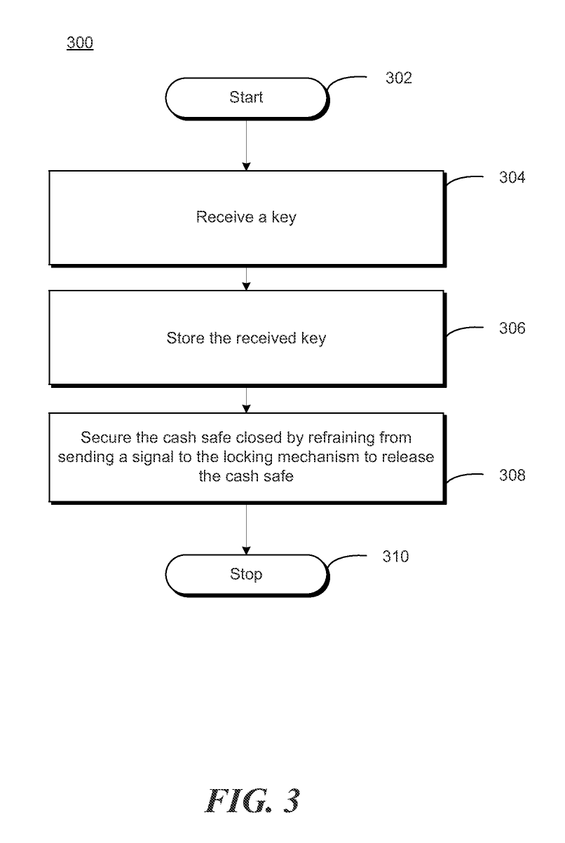

FIG. 3 is a flow chart illustrating one embodiment of a method 300 for securing the cash safe 104 with the circuit 210. In one embodiment, the cash safe 104 operates in both a secure and non-secure mode. For example, in a non-secure mode, the circuit 210 may receive an instruction, such as from the electronic device 102, to release the cash safe 104 allowing it to open. The circuit 210 may send a signal to the locking mechanism 106 which causes the locking mechanism 106 to release the cash safe 104 so that it may be, for example, removed from a drawer housing or a lid may be removed. The cash safe 104 may be secured such that the cash safe 104 evaluates a key prior to sending a signal to release the locking mechanism 106. Such a system may allow a user to determine whether to secure the cash safe 104. For example, a user may input information to the electronic device 102 to indicate that the circuit 210 should secure the cash safe 104.

Beginning at block 302 and moving to block 304, the circuit 210 receives a key, such as the key 214. The key 214 may be received from any suitable source, such as from the electronic device 102 via the communication interface 208. The electronic device 102 may create the key 214, for example by encrypting data or randomly selecting data. The electronic device 102 may create the key in response to a user request to secure the cash safe 104. In one implementation, an end user enters a key, such as through an input device connected to the electronic device 102. The key 214 may be created by a combination of user input and processing by the electronic device 102. In one embodiment, the electronic device 102 encrypts the key 214 prior to sending it to the circuit 210.

In one embodiment, the circuit 210 receives the key 214 by creating or retrieving it. For example, the electronic device 102 may instruct the circuit 210 to secure the cash safe 104, and the circuit 210 may retrieve a key stored in a storage medium, such as the storage 212. The retrieved key 214 may be a key previously received from the electronic device 102 or a key created by the circuit 210. For example, the circuit may create the key 214 by encrypting an identifier or other data associated with the cash safe 104. The circuit 210 may create the key 214 based on information received from the electronic device 102.

Moving to block 306, the circuit 210 stores the received information, such as in the storage 212. The circuit 210 may store the key 214, for example, so that the circuit 210 may access it later to evaluate whether to send a signal to the locking mechanism 106 to release the cash safe 104. The storage 212 may be a volatile storage or non-volatile storage. If the key 214 is stored in a volatile storage, the circuit 210 may write the key 214 to the storage 212 each time the storage 212 is reset. A non-volatile storage may be more secure because it may continue to be stored in the storage 212 in the event the storage 212 is powered down. In one embodiment, the circuit 210 stores a portion of the key 214 in a volatile storage medium and a portion of the key in a non-volatile storage medium. For example, one bit of the key 214 may be stored in a non-volatile storage. The portion of the key stored in the volatile storage medium may, for example, be updated each time the circuit 210 is reset.

In one embodiment, the circuit 210 receives multiple keys and permissions information associated with each key and stores the keys and associated permissions information in the storage 212. The permissions information may be useful, for example, to identify a user associated with the key or an activity allowed by the key. For example, a separate key may be used for an administrator, local user, and remote user.

Continuing to block 308, the circuit 210 secures the cash safe 104 closed by refraining from sending a signal to the locking mechanism 106 to release the cash safe 104. Any future user without the ability to transmit the proper key, such as by accessing an application capable of sending the proper key, may be unable to access the valuables stored within the cash safe 104. For example, in response to a request to release the cash safe 104, such as from the electronic device 102, the circuit 210 may compare the received key to the stored key 214 to determine whether the received key corresponds to the stored key 214. If not, the circuit 210 may refrain from sending a signal to the locking mechanism 106 to release the cash safe 104. In one embodiment, the electronic device 102 may instruct the circuit 210 to return to a non-secure mode such that it releases the cash safe 104 without evaluating a key. The method 200 may then continue to block 210 to end.

In one embodiment, the key 214 may be reset. For example, a user may want to update the key 214 in the event that information about the key 214 is compromised. In one embodiment, the circuit 210 receives a signal indicating that the key 214 may be reset, such as from the electronic device 102. A signal allowing the key 214 to be reset may prevent an unauthorized user from resetting the key 214 in order to gain access to the cash safe 104.

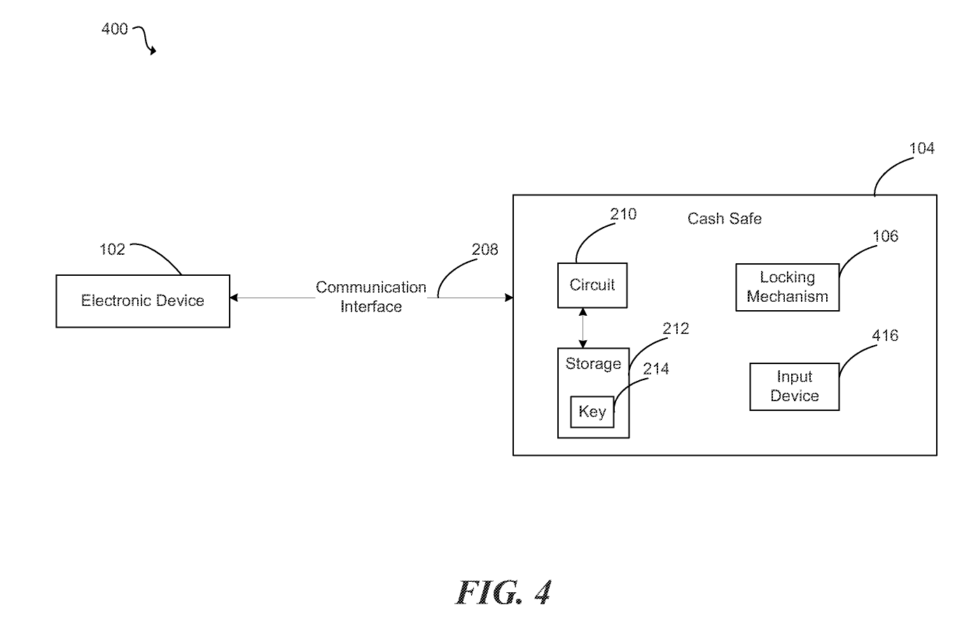

FIG. 4 is a block diagram illustrating one embodiment of an electronic cash safe system 400. The electronic cash safe system 400 includes the electronic device 102, the communication interface 208, the cash safe 104, and the storage 212. The electronic cash safe system 400 also includes an input device 416. The input device 416 may be any suitable input device, such as a button, and may be located in any suitable location, such as on the cash safe 104 or the electronic device 102. In one embodiment, the input device 416 may be selected to instruct the circuit 210 that the key 214 may be reset.

To reset the key 214, the circuit 210 may first receive a signal indicating that the stored key may be updated, such as from the electronic device 102 or the input device 416. The circuit 210 may receive an updated key, such as via the communication interface 208. The circuit 210 may replace the stored key 214 with the received updated key. In one embodiment, the circuit 210 stores the new key and continues to store the previous key 214. In one embodiment, the circuit 210 resets a portion of the key 214, such as a portion of the key 214 stored in a volatile storage or a portion of the key 214 stored in a non-volatile storage.

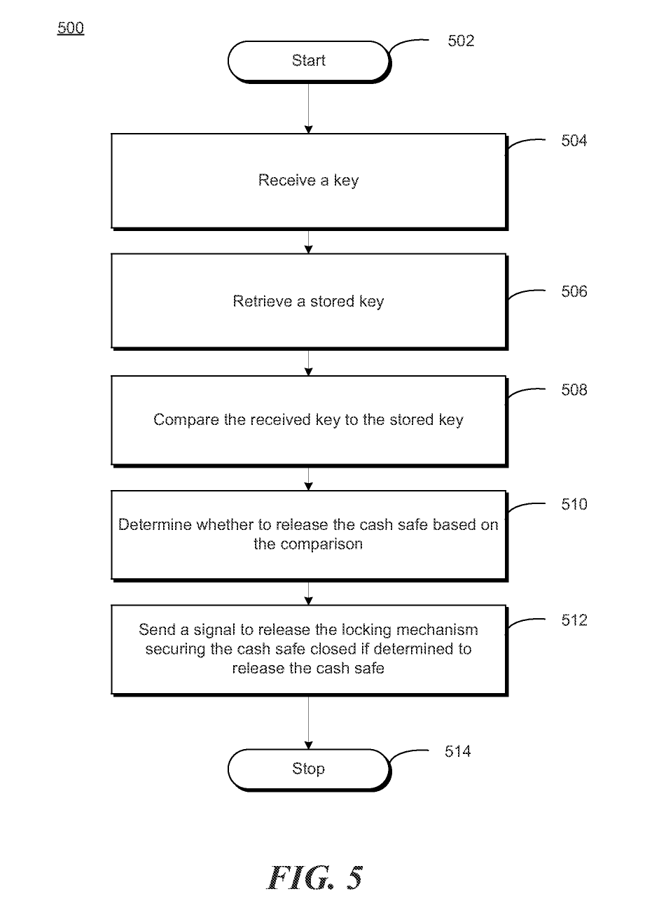

FIG. 5 is a flow chart illustrating one embodiment of a method 500 for opening the cash safe 104 secured with the circuit 210. In one embodiment, the cash safe 104 is secured such that it evaluates a received key to determine whether to send a signal to the locking mechanism 106 to release the cash safe 104. For example, the circuit 210 may determine whether a received key corresponds to the key 214 that the circuit 210 previously stored in the storage 212.

Beginning at block 502 and moving to block 504, the circuit 210 receives a key. The key may be any suitable information and may be received in any suitable manner. For example, in one embodiment, the circuit 210 receives the key from the communication interface 208. The key may be sent across the communication interface 208, for example, from an application on the electronic device 102. In one embodiment, the electronic device 102 encrypts a key or retrieves an encrypted key to transmit to the circuit 210. In one embodiment, the electronic device 102 performs a hashing method on an identifier or serial number associated with the cash safe 104 and sends the encrypted information to the circuit 210. In one embodiment, the key is originally entered by an end user, for example, by using an input device connected to the electronic device 102. An end user may instruct the electronic device 102 to send a key, and the electronic device 102 may create or retrieve a key to transmit to the circuit 210. In one implementation, a higher level password system is also used. For example, the electronic device 102 may determine whether a user entered a correct password and send a key to the circuit 210 if the user entered the correct password.

In one embodiment, the circuit 210 receives the key by retrieving it from a storage medium accessible by the circuit 210. For example, the circuit 210 may receive an instruction from the electronic device 102 to retrieve a key. In one embodiment, the electronic device 102 transmits a portion of the key, and the circuit 210 also retrieves a portion of the key.

Moving to block 506, the circuit 210 retrieves a stored key. For example, the circuit 210 may retrieve the key 214 from the storage 212. Proceeding to block 508, the circuit 210 compares the received key to the stored key 214. In one embodiment, the circuit 210 processes, such as by decoding, the received key or the stored key 214 prior to comparing the keys. In one embodiment, the circuit 112 compares the keys to determine whether the keys correspond, such as by matching. In one embodiment, the circuit 112 checks to see whether a portion of the keys correspond to one another.

Continuing to block 510, the circuit 210 determines whether to release the cash safe 104 based on the comparison. The circuit 210 may determine to release the cash safe 104, for example, if the received key and the stored key 214 correspond, such as by matching or having a portion that matches. In one embodiment, the circuit 210 considers other factors in addition to the comparison of the keys.

In one embodiment, the circuit 210 stores multiple keys in the storage 212. The storage 212 may store permission information associated with each of the keys. The circuit 210 may determine whether the received key corresponds to any of the stored keys. If the received key corresponds to one of the stored keys, the circuit 210 may check the permissions associated with the stored key to determine whether to release the cash safe 104. The permissions information may, for example, indicate a time that the key may be used or a device from which the key may originate.

Proceeding to block 512, the circuit 210 sends a signal to release the locking mechanism 106 securing the cash safe 104 closed if determined to release the cash safe 104. In some implementations, the cash safe 104 automatically opens when receiving the signal from the circuit 210. In some cases, the cash safe 104 may be opened by a user once the cash safe 104 receives the signal from the circuit 210. The method 500 then continues to block 514 and ends.

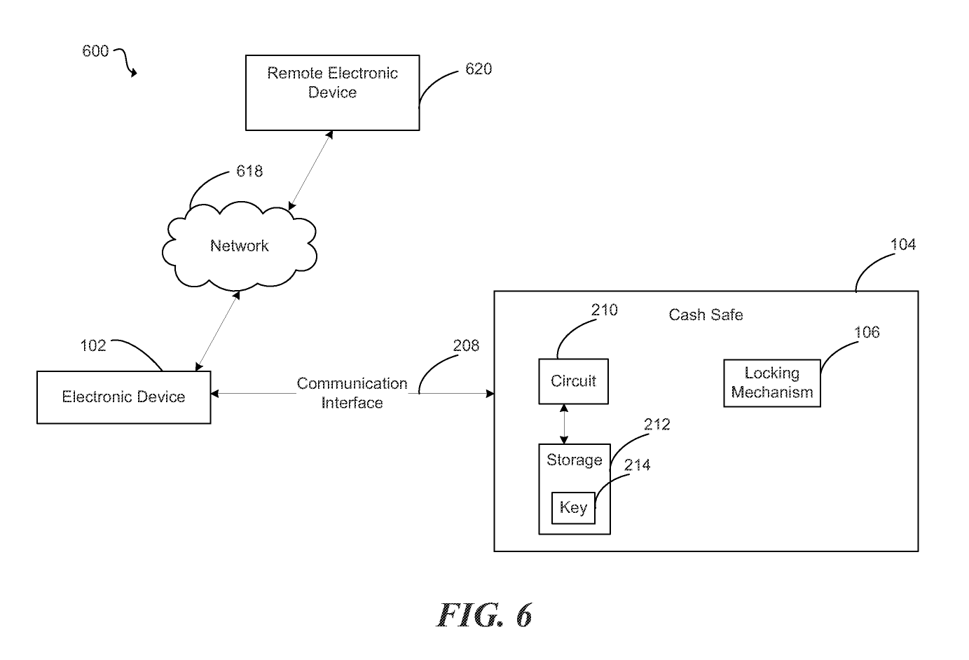

FIG. 6 is a block diagram illustrating one embodiment of an electronic cash safe system 600. The electronic cash safe system 600 includes the electronic device 102, the circuit 210, and the cash safe 104. The electronic cash safe system 600 may include a network 618. The network 618 may be any suitable type of network, such as the Internet or a local area network. In one embodiment, a remote electronic device 620, such as a computer, communicates with the electronic device 102 via the network 618. For example, the remote electronic device 620 may send a key or an instruction to send a key to the electronic device 102 which may then communicate the information to the circuit 210.

In one embodiment, the remote electronic device 620 communicates with multiple circuits and cash safes via the network 618. For example, if an alarm alerts a remote user that a bank robbery is taking place, the user may input information into the remote electronic device 620 so that the remote electronic device 620 sends instructions to each of the local electronic devices, such as the electronic device 102, to secure their associated cash safes.

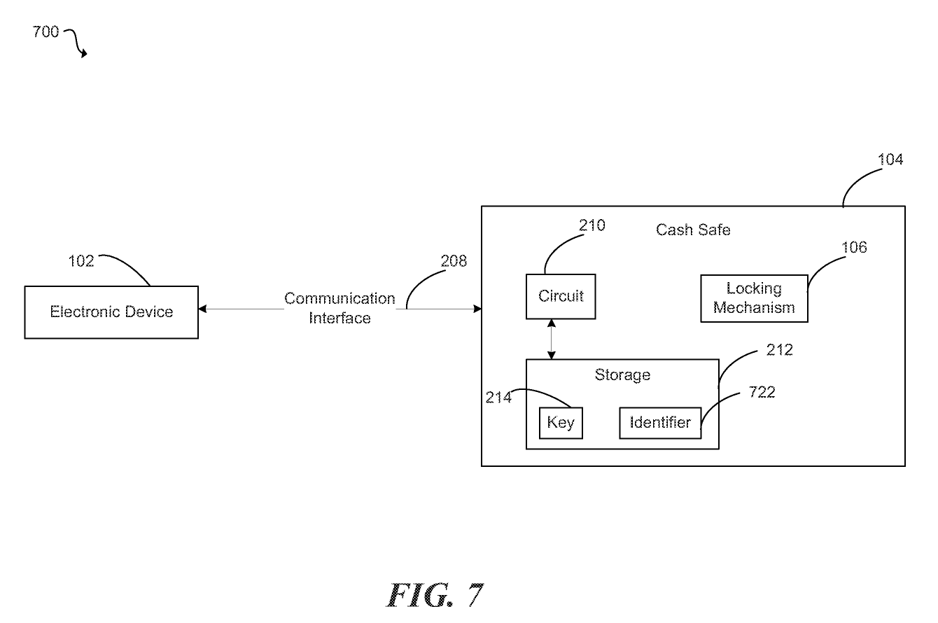

FIG. 7 is a block diagram illustrating one embodiment of an electronic cash safe system 700. The electronic cash safe system 700 includes, for example, the cash safe 104 and the storage 212. In one embodiment, the storage 212 stores an identifier 722. The identifier 722 may be any suitable identifier, such as a serial number. The identifier may be, for example, unique to a particular cash safe in a group of cash safes. In one embodiment, the identifier 722 is stored in a separate storage medium than the key 214. The circuit 210 may receive the identifier 722 or an updated version of the identifier 722, for example, from the electronic device 102 and store it in the storage 212. In one implementation, the identifier 722 is a read only identifier such that the electronic device 102 may not change the identifier 722.

In one embodiment, the circuit 210 retrieves the identifier 722 from the storage 212. The circuit 210 may send the identifier 722 via the communication interface 208 to the electronic device 102, such as prior to or after securing the cash safe 104. The electronic device 102 may use the identifier 722 to track multiple cash safes in a system. For example, a remote electronic device may receive information identifying a cash safe in order to determine which cash safes should be secured.

Embodiments disclosed herein provide advantages. For example, a cash safe secured by a circuit evaluating a key may be more difficult to interfere with than other security methods. A cash safe that operates in both a secure and non-secure mode may allow the cash safe to be secured according to the circumstances and may allow for remote securing of a cash safe or a group of cash safes. In addition, a cash safe that stores an identifier associated with it may be useful in a system with multiple cash safes for tracking the security of a cash safe and the assets contained in an individual cash safe.

1. An electronic cash safe system, comprising:
a cash safe;
a locking mechanism positioned to secure the cash safe closed;
a storage; and
a circuit configured to:
store a key in the storage; and
send a signal to the locking mechanism to release the cash safe if the circuit receives a key corresponding to the key stored in the storage.

2. The electronic cash safe system of claim 1, further comprising an input device for instructing the circuit that an updated key may be stored in the storage.

3. The electronic cash safe system of claim 1, further comprising a communication interface connected to the circuit, wherein the circuit receives a key via the communication interface.

4. The electronic cash safe system of claim 3, further comprising:
an electronic device in communication with the circuit via the communication interface; and
a network,
wherein the electronic device receives a key via the network and communicates the received key to the circuit via the communication interface.

5. The electronic cash safe system of claim 1, wherein the storage stores an identifier associated with the cash safe.

6. The electronic cash safe system of claim 1, wherein the storage stores multiple keys and permissions information associated with each key.

7. A method for securing a cash safe with a circuit, comprising:
receiving a key by a circuit connected to a locking mechanism for securing a cash safe closed;
storing, by the circuit, the received key; and
securing, by the circuit, the cash safe closed by refraining from sending a signal to the locking mechanism to release the cash safe.

8. The method of claim 7, further comprising transmitting, by the circuit, a signal to release the locking mechanism securing the cash safe closed if determined that a received key corresponds to the stored key.

9. The method of claim 7, further comprising:
receiving, by the circuit, permissions information associated with the received key; and
storing, by the circuit, the permissions information.

10. The method of claim 7, further comprising:
receiving, by the circuit, an instruction indicating that the stored key may be updated;
receiving, by the circuit, an updated key; and
storing, by the circuit, the updated key.

11. The method of claim 7, wherein storing the received key comprises storing a portion of the received information in a volatile storage and storing a portion of the received information in a non-volatile storage.

12. A method for opening a cash safe secured with a circuit, comprising:
receiving a key by a circuit connected to a locking mechanism for securing a cash safe closed;
retrieving, by the circuit, a stored key;
comparing, by the circuit, the received key to the stored key;
determining, by the circuit, whether to release the cash safe based on the comparison; and
sending, by the circuit, a signal to release the locking mechanism securing the cash safe closed if determined to release the cash safe.

13. The method of claim 12, further comprising:
retrieving, by the circuit, an identifier associated with the cash safe; and
sending, by the circuit, the identifier to an electronic device.

14. The method of claim 12, wherein determining whether to release the cash safe comprises:
decoding, by the circuit, the received key; and
comparing, by the circuit, the decoded key to the stored key.

15. The method of claim 12, wherein determining whether to release the cash safe further comprises:
receiving, by the circuit, permissions information associated with a stored key corresponding to the received key; and
determining, by the circuit, whether to release the cash safe based on the received permissions information.
